(19) United States
(12) Patent Application Publication
(10) Pub. No.: US 2009/0032623 A1
(43) Pub. Date: Feb. 5, 2009

(54) Fuel Injector

(76) Inventors: Markus Gesk, Karlsbad (DE); Guenter Dantes, Eberdingen (DE); Joerg Heyse, Besigheim (DE)

Correspondence Address: KENYON & KENYON LLP, ONE BROADWAY, NEW YORK, NY, 10004, US

(21) Appl. No.: 11/664,633

(22) PCT Filed: Sep. 20, 2005
(86) PCT No.: PCT/EP05/54695

§ 371 Date: Mar. 11, 2008

(30) Foreign Application Priority Data
Oct. 9, 2004 (DE) 102004049281.6

(51) Int. Cl. B05B 1/30

(52) U.S. Cl. 239/584

(57) ABSTRACT

The fuel injector includes an orifice plate being situated downstream from a valve-seat body having a fixed valve seat, the orifice plate having at least one outlet opening. Provided directly upstream from the outlet openings is an inflow opening having an annular inflow cavity. The valve-seat body covers the inflow cavity in such a way that the downstream outlet openings of the orifice plate are covered. A boundary surface of the valve-seat body lying opposite the orifice plate is designed such that, beginning at an exit opening, the height of the inflow opening decreases continuously in a first section up to the at least one outlet opening, while the height of the inflow opening in a second, radially outer section remains largely constant. The fuel injector is particularly suitable for use in fuel injection systems of the mixture-compressing internal combustion engines having external ignition.

### BACKGROUND INFORMATION

A fuel injector with an orifice plate having a plurality of outlet openings downstream from a fixed valve seat is described in German Patent Application No. DE 42 21 185. Using stamping, the orifice plate is first provided with at least one outlet opening, which extends parallel to the longitudinal valve axis. The orifice plate is then plastically deformed in its mid-section where the outlet openings are located, by deep-drawing, so that the outlet openings extend at an incline relative to the longitudinal valve axis and widen frustoconically or conically in the direction of the flow. In this manner, good conditioning and jet stability of the medium discharged through the outlet openings are achieved compared to the fuel injectors known heretofore; however, the manufacturing process of the orifice plate with its outlet openings is very complex. The outlet openings are provided immediately downstream from an exit opening in the valve-seat body and thus are directly exposed to the flow, the outlet openings themselves defining the narrowest cross section of the flow.

A fuel injector in which an orifice plate having a plurality of outlet orifices is provided downstream from the valve seat is already known from Japanese Patent No. JP 2001-046919. Formed between an exit opening in the valve-seat body and the orifice plate is an inflow opening having a larger diameter, which forms an annular inflow cavity for the outlet openings. The outlet openings of the orifice plate are in direct flow connection with the inflow orifice and the annular inflow cavity and covered by the upper boundary of the inflow orifice. In other words, there is a complete offset from the exit opening determining the intake of the inflow opening and the outlet openings. The radial offset of the outlet openings with respect to the exit opening in the valve-seat body produces an s-shaped flow pattern of the fuel, which represents an atomization-promoting measure; however, in a disadvantageous manner the outlet openings form the narrowest cross section of the flow and reduce the atomization quality. The inflow opening determining the s-shaped characteristic of the flow has a constant height throughout.

### SUMMARY OF THE INVENTION

The fuel injector according to the present invention has the advantage that a uniform and very fine atomization of the fuel is achieved in a simple manner, and an especially high conditioning and atomization quality with very tiny fuel droplets is obtained. This is advantageously achieved by providing an inflow opening having an annular inflow cavity in the valve-seat body, upstream from the outlet openings, the inflow opening being larger than an exit opening downstream from the valve seat. In this way the valve-seat body already assumes the function of a flow control in the orifice plate. In an especially advantageous manner, due to the design of the inflow opening, an s-deflection is achieved in the flow for better atomization of the fuel since the valve-seat body covers the outlet openings of the orifice plate by the upper boundary of the inflow opening. Due to the steady reduction in the height of the inflow opening, beginning at the exit opening and ending at the outlet openings in the orifice plate, the flow in the inflow opening is advantageously accelerated in an atomization-promoting manner.

The horizontal velocity components of the flow discharging into the entry plane are not impeded by the wall of the individual outlet orifice at the entry plane, so that the fuel jet has the full intensity of the horizontal components generated in the inflow cavity when leaving the outlet opening and thus fans out at maximum atomization.

It is especially advantageous if, downstream from a valve seat, a flow-exposed through-flow area above the at least one outlet opening in the inflow cavity provided upstream from the orifice plate is smaller than the area of the entry plane of the outlet opening, the through-flow area being calculated as the product of the circumference of the outlet opening in the region of its entry plane and the free height in the inflow cavity of the inflow opening.

Using galvanic metal deposition, orifice plates may be produced simultaneously in an advantageous and reproducible manner, in very large lot numbers and extremely precisely and cost-effectively. Moreover, this manufacturing method allows extremely great freedom in design since the contours of the openings in the orifice plate are freely selectable.

### BRIEF DESCRIPTION OF THE DRAWINGS

FIG. 1 shows a partially illustrated fuel injector.

FIG. 2 shows an enlarged view of the cutaway portion 11 in FIG. 1, with the inflow cavity configured according to the present invention.

FIG. 3 shows the same cutaway portion 11 with a second specific embodiment.

### DETAILED DESCRIPTION

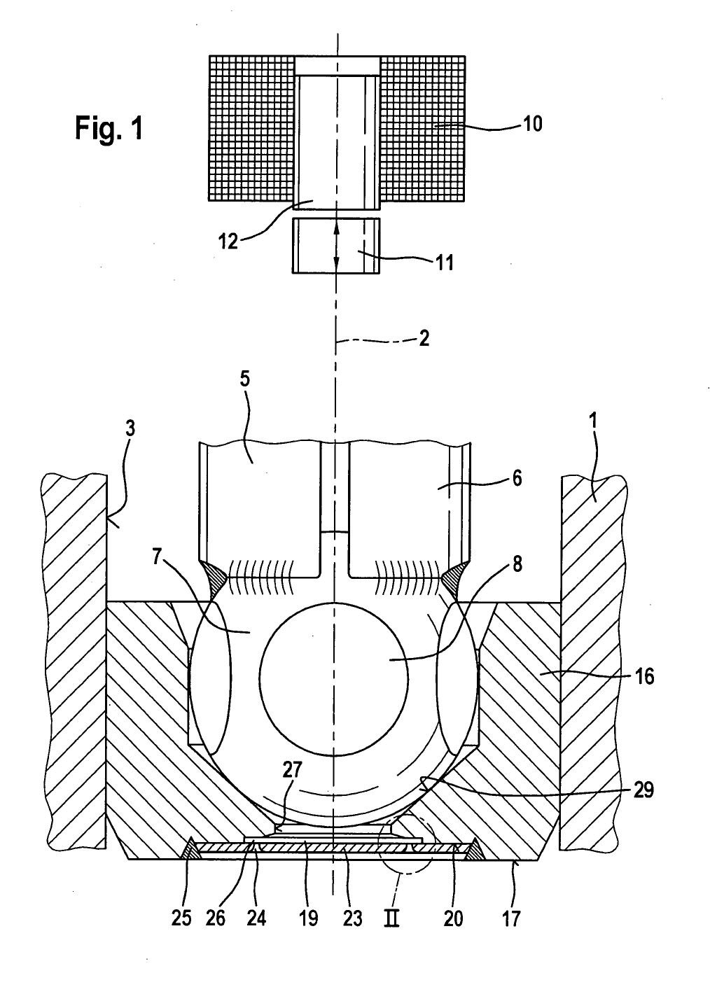

FIG. 1 shows as an exemplary embodiment a partial view of a valve in the form of a fuel injector for fuel injection systems of mixture-compressing, externally ignited internal combustion engines. The fuel injector has a tubular valve-seat support 1, indicated only schematically, which constitutes part of a valve housing and in which a longitudinal opening 3 is formed concentrically to a longitudinal valve axis 2. Situated in longitudinal opening 3 is, for example, a tubular valve needle 5, which is fixedly joined at its downstream end 6 to a spherical valve closure member 7, for instance, at whose periphery five flattened regions 8, for example, are provided for the fuel to flow past.

The fuel injector is actuated in a known manner, e.g. electromagnetically. A schematically sketched electromagnetic circuit, which includes a magnetic coil 10, an armature 11 and a core 12, is used for axial displacement of valve needle 5, and thus for opening the fuel injector against the spring tension of a restoring spring (not shown), or for closing it. Armature 11 is connected to the end of valve needle 5 facing away from valve-closure member 7 by a welding seam, for instance, formed by laser, and points to core 12.

A valve-seat body 16 is mounted in the downstream end of valve-seat support 1, for instance by welding, so as to form a seal. At its lower front end 17, facing away from valve-closure member 7, valve-seat body 16 has a stepped design, and a recess 20 is provided in a center region about longitudinal valve axis 2 in which a flat, for instance one-layer orifice plate 23 is inserted. Orifice plate 23 has at least one, but ideally two to forty outlet openings 24. Provided upstream from recess 20, and thus from outlet openings 24 of orifice plate 23, is an inflow opening 19 in valve-seat body 16, via which the individual outlet openings 24 are approached by the flow. Inflow opening 19 has a larger diameter than the opening width of an exit opening 27 in valve-seat body 16 from whence the fuel flows into inflow opening 19 and finally into outlet openings 24.

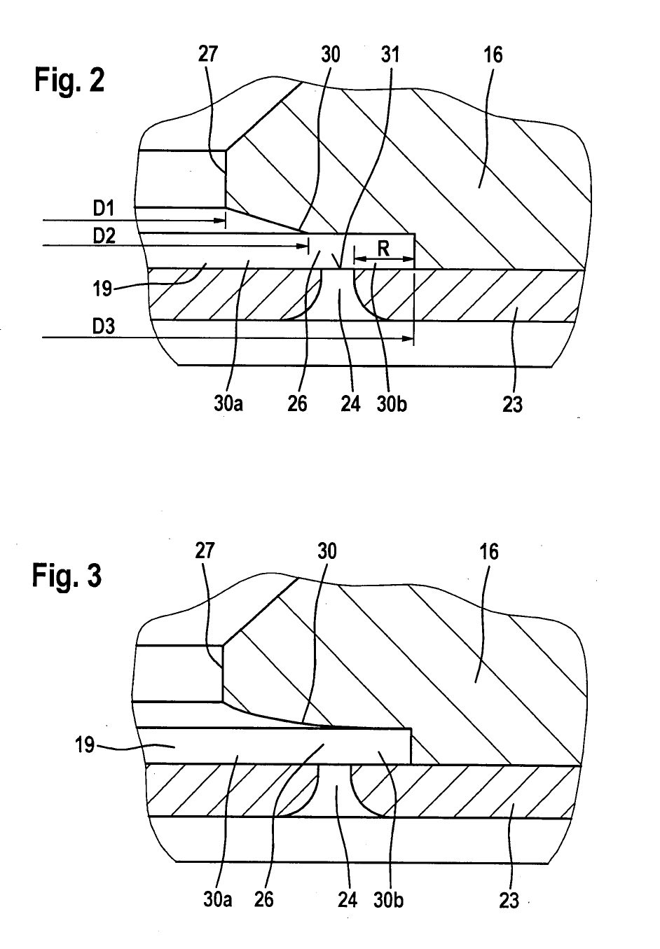

According to the present invention, inflow opening 19 has a special geometry, in particular in the immediate inflow region of outlet openings 24. The annular region of inflow opening 19, which has a larger diameter than exit opening 27, is shown in FIGS. 2 and 3 in an enlarged view, elucidated in greater detail on the basis of these figures, and denoted as inflow cavity 26 in the following text.

The connection of valve-seat body 16 and orifice plate 23 is implemented by, for instance, a circumferential and sealing welding seam 25, formed by laser, which is situated outside of inflow opening 19. Once orifice plate 23 has been fixed in place, it is positioned in recess 20 in a recessed manner relative to end face 17.

The insertion depth of valve-seat body 16 with orifice plate 23 in longitudinal opening 3 determines the magnitude of the lift of valve needle 5 since, in the case of a non-energized magnetic coil 10, one end position of valve needle 5 is defined by the seating of valve-closure member 7 on a valve-seat surface 29 of valve-seat body 16, which tapers conically in a downstream direction. When magnetic coil 10 is energized, the other end position of valve needle 5 is defined by, for instance, the seating of armature 11 on core 12. The path between these two end positions of valve needle 5 therefore constitutes the lift.

As an alternative to the exemplary embodiment shown in FIG. 1, orifice plate 23 may also be made up of, for example, two layers with two functional planes on top of one another.

Outlet openings 24 of orifice plate 23 are in direct flow connection with inflow opening 19 and annular inflow cavity 26 and covered by the upper boundary of inflow opening 19. In other words, there is a complete offset from exit opening 27 defining the intake of inflow opening 19, and outlet openings 24. The radial offset of outlet openings 24 with respect to exit opening 27 brings about an s-shaped flow pattern of the medium, in this case the fuel.

The so-called s-twist in front of and within orifice plate 23, with several pronounced flow deflections, imparts a strong, atomization-promoting turbulence to the flow. The velocity gradient transversely to the flow is thereby particularly pronounced. It is an expression for the change in the velocity transversely to the flow, the velocity in the center of the flow being markedly greater than in the vicinity of the walls. The greater shear stresses in the fluid resulting from the velocity differences promote the disintegration into fine droplets close to outlet openings 24. According to the present invention, due to the specific geometry of inflow opening 19 or inflow cavity 26, the fluid is influenced even further in its atomization in an advantageous manner by its permanent acceleration, so that an even better disintegration into the finest droplets is able to be achieved.

Orifice plate 23 is produced by galvanic metal deposition, for instance; the production of a one-layer orifice plate 23 utilizing lateral overgrowth technology, in particular, is advantageous. Orifice plate 23 may also be produced by stamping. Outlet openings 24 ideally have a trumpet-shaped contour or a contour that resembles a Laval nozzle. The cross section of outlet openings 24 may have a circular, oval or also multi-sided form, for example.

FIG. 2 shows an enlarged cutaway portion 11 from FIG. 1 to illustrate the geometry of inflow opening 19 or inflow cavity 26 between boundary surface 30 of valve-seat body 16 and orifice plate 23. Valve-seat body 16 is designed such that, beginning at exit opening 27 (diameter D1), boundary surface 30 steadily decreases at an angle in a radially outward direction in the direction of orifice plate 23 in a first section 30a, to a diameter D2. A step or bend is provided in boundary surface 30 in the region of diameter D2, next to which is a second section 30b of inflow opening 19 in the radially outward direction, which is largely delimited perpendicular to longitudinal valve axis 2 by boundary surface 30. While the height of inflow opening 19 becomes increasingly smaller in first section 30a viewed in the flow direction, second section 30b thus has a largely constant height. The transition from the first to the second section of boundary surface 30 (diameter D2) is located directly in front of outlet openings 24, immediately along the boundary edges of outlet openings 24 or above outlet openings 24. This has the result that, above an entry plane 31, extending perpendicular to longitudinal valve axis 2, of the at least one outlet opening, only a low height of inflow cavity 26 remains, and the flow is accelerated in a steady and atomization-promoting manner on the way from exit opening 27 to outlet openings 24. The diameter of the entire inflow opening 19 including a rear space R, situated radially beyond outlet openings 24, is denoted by D3.

Ideally, an imaginary, flow-exposed perpendicular flow-through area above outlet opening 24 in inflow cavity 26, which is calculated as the product of the circumference of outlet opening 24 in the region of its entry plane 31, and the free height in inflow cavity 26, is smaller than the area of entry plane 31 of outlet opening 24. The highest atomization quality is achieved if this ratio is observed at all outlet openings 24 of orifice plate 23.

In the afore-described size ratios, the imaginary flow-through area is the smallest quantity-metering cross section in the flow path. Entry plane 31 of outlet opening 24 offers the entering flow a larger cross-sectional surface than required for the flow rate pre-metered via flow-through area 32. This being the case, the flow is completely detached from the wall of outlet opening 24 in entry plane 31. The horizontal velocity components of the flow discharging into entry plane 31 are thus not impeded by the wall of outlet opening 24 at entry plane 31, so that the fuel jet has the full intensity of the horizontal component generated in inflow cavity 26 when leaving outlet opening 24 and therefore fans out at maximum atomization.

FIG. 3 shows an enlarged view of an additional inflow cavity 26 configured according to the present invention in the form of an annular region of inflow opening 19, in a cutaway that is comparable to FIG. 2. In this exemplary embodiment, boundary surface 30 of valve-seat body 16 extends in parabolic form in a convexly shaped manner beginning at exit opening 27, this first section 30a of boundary surface 30 above the at least one outlet opening 24 transitioning smoothly into second section 30b extending largely perpendicular to longitudinal valve axis 2 and having a constant height.

1-8. (canceled)

9. A fuel injector for a fuel-injection system of an internal combustion engine, having a longitudinal valve axis, the fuel injector comprising:
a valve-seat body having a fixed valve seat;
a valve-closure member, which cooperates with the valve seat and is axially displaceable along the longitudinal valve axis; and
an orifice plate, which is situated downstream from the valve seat and has at least one outlet opening,
wherein an inflow opening is defined between a diameter-reduced exit opening of the valve-seat body and the at least one outlet opening, and
wherein a boundary surface of the valve-seat body lying opposite the orifice plate is designed such that, starting at the exit opening, a height of the inflow opening in a first section decreases continuously up to the at least one outlet opening, while a height of the inflow opening in a second, radially outward section remains substantially constant.

10. The fuel injector according to claim 9, wherein the first section is delimited by a planar, inclined boundary surface.

11. The fuel injector according to claim 9, wherein the first section is delimited by a boundary surface that is curved in parabolic form.

12. The fuel injector according to claim 9, wherein a transition from the first section to the second section is situated immediately in front of the at least one outlet opening, directly at a boundary edge of the at least one outlet opening, or above the at least one outlet opening.

13. The fuel injector according to claim 9, wherein the at least one outlet opening has one of (a) a trumpet-shaped contour and (b) a contour in a shape of a naval nozzle.

14. The fuel injector according to claim 9, wherein the orifice plate is produced with the aid of one of galvanic metal deposition and stamping technology.

15. The fuel injector according to claim 9, wherein an imaginary, flow-exposed flow-through area above the at least one outlet opening in the inflow opening provided upstream from the orifice plate, which is calculated as a product of a circumference of the outlet opening in a region of its entry plane and a free height in the inflow opening, is smaller than an area of an inflow plane of the outlet opening.

16. The fuel injector according to claim 15, wherein between two and forty outlet openings are situated in the orifice plate, and the flow-exposed flow-through area above each outlet opening in the inflow opening is smaller than an area of the entry plane of the respective outlet opening.
